(19) United States
(12) Patent Application Publication
(10) Pub. No.: US 2026/0017682 A1
(43) Pub. Date: Jan. 15, 2026

(54) Verified User Polling and Data Platform with Trend-Based Question Generation, Identity-Gated Access, and Optional NFT Integration

(71) Applicant: Technico LLC, Sheridan, WY (US)

(72) Inventor: Nicolas Scatino, Scottsdale, AZ (US)

(73) Assignee: Technico LLC, Sheridan, WY (US)

(21) Appl. No.: 19/268,804

(22) Filed: Jul. 14, 2025

Related U.S. Application Data
(60) Provisional application No. 63/671,174, filed on Jul. 13, 2024.

(51) Int. Cl. G06Q 30/0203; G06F 21/32; G06F 21/62; G06Q 30/0217

(52) U.S. Cl. CPC G06Q 30/0203; G06F 21/32; G06F 21/6254; G06Q 30/0217

(57) ABSTRACT

The invention enables verified civic engagement through a secure, scalable platform for polls, surveys, and quizzes. It supports centralized or decentralized hosting, where users verify identity via photo ID, biometrics, or similar methods and receive an Encrypted Access Code for login and wallet access. Three polling boards (Platform-Generated, User-Submitted, Organization), branded as “Vote Your Voice,” and a required Make a Difference Board display ranked content. The Make a Difference Board highlights causes submitted by users, organizations, or the platform. Users earn credits for participation, redeemable for features or mintable as NFTs via the optional Wallet and NFT Module. Organizations access anonymized insights. The required Events Module enables local event discovery with rewards, managed through an organization interface. Live Fact-Checking supports real-time validation. The Alignment Comparison Module compares user responses to official actions or benchmarks. A required Contextual Overlay Engine visualizes data. Optional secure messaging allows private communication between verified users.

### CROSS-REFERENCE TO RELATED APPLICATIONS

This application claims benefit of priority from U.S. Provisional Application Ser. No. 63/671,174, filed Jul. 13, 2024, the entire contents of which are hereby incorporated by reference.

### FIELD OF THE INVENTION

The present invention relates to digital data and engagement platforms. Specifically, it pertains to a system and method configured to conduct secure, verified user polling and data analysis, featuring automated question generation, a credit-based user economy, and optional blockchain integration.

The system is particularly suited for applications requiring verified identity polling, decentralized data control, and incentive-aligned civic engagement.

### BACKGROUND OF THE INVENTION

Online polling and survey platforms are widely utilized to gauge public opinion, conduct market research, and foster engagement. However, existing solutions exhibit deficiencies that undermine data reliability, neutrality, and value.

First, the absence of robust user identity verification enables manipulation by automated bots, multiple-account actors, and coordinated campaigns (e.g., “ballot stuffing”), rendering data untrustworthy for academic, commercial, or civic use.

Second, poll questions often contain inherent bias, reflecting creator presuppositions rather than genuine sentiment, necessitating neutral question generation. Biased or leading questions can render the data collected from those questions untrustworthy.

Third, user engagement remains transient due to inadequate incentives, yielding low response rates and unrepresentative data sets, with superficial gamification failing to sustain participation or build a lasting economy. Low response rates can reduce the accuracy and trustworthiness of collected data sets.

Finally, monetization of user data raises privacy concerns, as platforms harvest and sell data non-transparently, limiting user control. If a platform loses the trust of the users, they may be less likely to participate in questionnaires or financial transactions.

Thus, a platform integrating mandatory identity verification, intelligent content generation, a robust credit economy, and a transparent data framework is needed to bridge online discourse with civic action.

### SUMMARY OF THE INVENTION

The present disclosure introduces a secure, adaptable digital platform for user, organizational, and institutional engagement through polls, surveys, and quizzes in a verified environment. It ensures privacy and resilience by offering flexible hosting options, including centralized or decentralized systems, backed by secure APIs, decentralized ledgers, and data anonymization. Users verify their identity to receive an Encrypted Access Code, which grants secure access and enables integration with crypto wallets and NFT creation. The platform empowers users to generate visual assets like profile pictures and NFTs, including badges for achievements.

Key features include an Events Module for discovering and attending events, and a Community and Organization Content Board for ranking causes. A Polling and Data Engine drives various content boards for dynamic interaction. Users influence content visibility by upvoting or downvoting and earn credits for activities, which can be redeemed for posting or boosting content. All data shared externally is anonymized, safeguarding user privacy. The platform also offers advanced capabilities like live fact-checking and representative voting alignment, with plans for future expansion into immersive experiences using technologies like AR and VR.

### BRIEF DESCRIPTION OF THE DRAWINGS

The appended drawings illustrate typical embodiments and are not limiting.

FIG. 1 illustrates the System Architecture, featuring solid boxes for required modules (Events Module, Community and Organization Content Board, Contextual Overlay Engine) and dashed outlines for optional modules (NFT/Wallet and Encrypted Code Integration System, Secure Messaging System). Dashed arrows represent optional integration paths that are only activated when the corresponding optional modules are enabled.

FIG. 2 illustrates the User Verification and Login Flow, highlighting identity verification, Encrypted Access Code issuance, and optional Blockchain Wallet and NFT Module with dashed outlines.

FIG. 3 illustrates the Trend Processing and Poll Generation Workflow, incorporating the Contextual Data Collector Module.

FIG. 4 illustrates the Credit Management and User Rewards System, detailing credit accrual and integration with the NFT/Wallet and Encrypted Code Integration System.

FIG. 5 illustrates the Organizational Content Dashboard, including data access and monetization interfaces.

FIG. 6 illustrates the Categorized Community Content Boards, showing user ranking mechanisms.

FIG. 7 illustrates the Live Fact-Checking Module, depicting real-time claim validation.

FIG. 8 illustrates the Social Sharing Module, including sharing options and alerts.

FIG. 9 illustrates the Wallet and NFT Integration Module, showcasing profile image and NFT generation with the Credit/Achievement Conversion Module.

FIG. 10 illustrates the Data Analytics and Monetization Engine, including the required Contextual Overlay Engine, integrated with the Data Insights Engine, Alignment Comparison Module, and Insight Delivery Module.

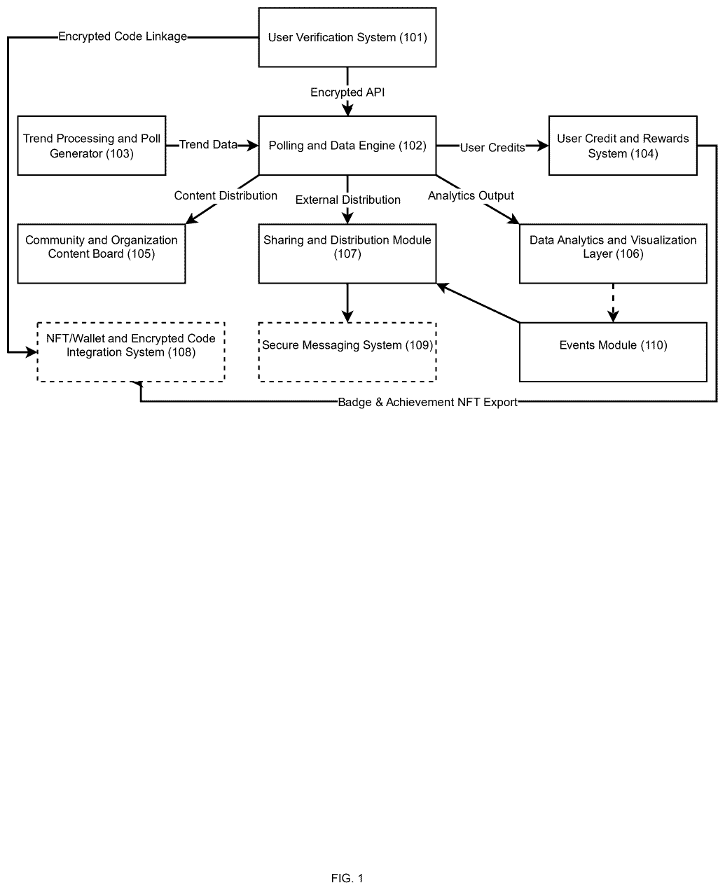

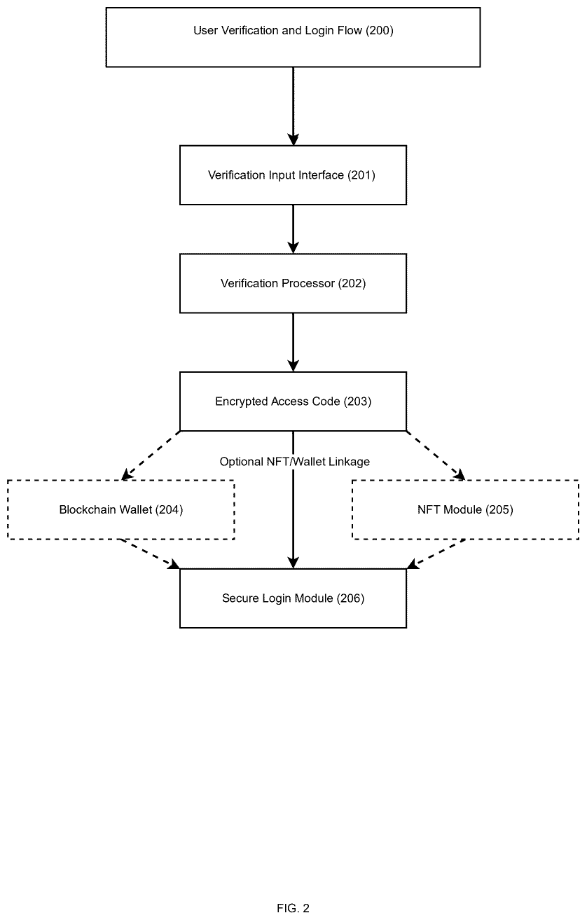

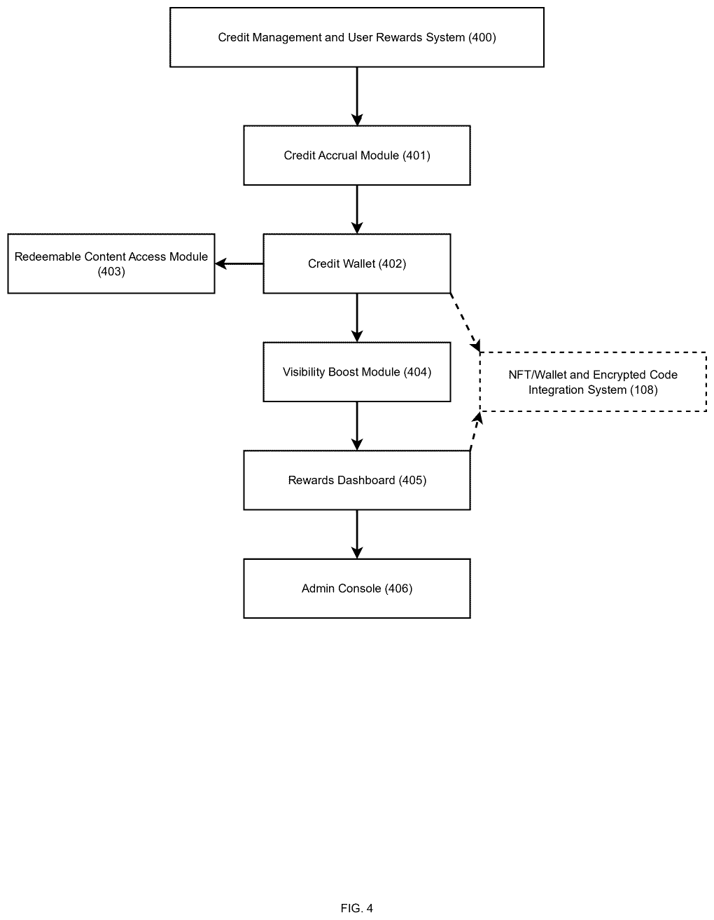

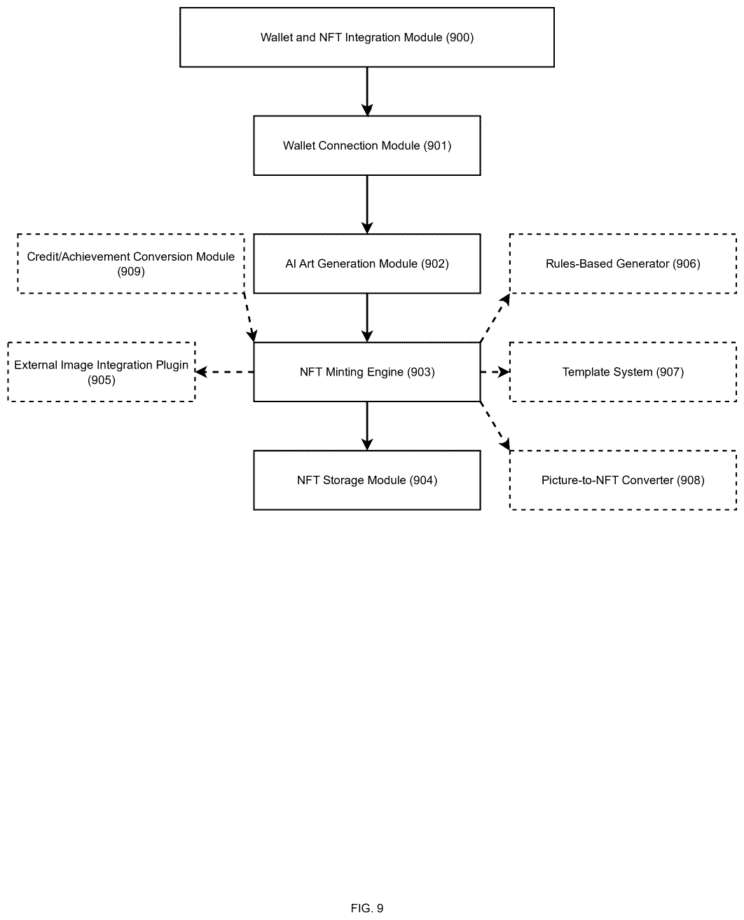

NOTE: FIGS. 4 and 9 reflect interoperable pathways between the Rewards Dashboard, Credit Wallet, and the NFT/Wallet and Encrypted Code Integration System, with solid arrows for supported optional flows. Figures may require updates to align with the required status of Events Module, Community and Organization Content Board, and Contextual Overlay Engine in FIG. 1, and to clarify optional Blockchain Wallet and NFT Module in FIG. 2.

### DETAILED DESCRIPTION

The present invention provides a secure, modular, and scalable digital engagement platform configured to facilitate user, organizational, and institutional interaction through polls, surveys, quizzes, or some combination thereof, in a verified environment. As used in this specification, the term “User Dashboard” refers to a user-facing interface that aggregates several engagement and feedback elements for the verified user. This includes, but is not limited to, the Rewards Dashboard, Credit Wallet, Event Participation Tracker, Content Submission Interface, and Saved Content Feed. The User Dashboard provides a centralized view of the user's verified activities, credit balances, achievements, contributions, and engagement with polls, surveys, and events within the platform. The platform supports centralized or decentralized hosting, utilizing multiple rotating independent servers, secure APIs, decentralized ledgers, and an anonymization layer to ensure privacy and resilience.

Platform deployment may occur across hybrid infrastructures, supporting both centralized and decentralized environments for resilience and trust.

In some embodiments, users may verify identity via the application or a third-party service using methods including, but not limited to, photo ID, facial recognition, video, email/SMS, two-step verification, or biometric scans. Upon successful verification, the user may be issued an Encrypted Access Code for platform login, data access, profile personalization, and integration with internal or external crypto or NFT wallets. Users may generate visual assets, for example and without limitation: profile pictures or NFTs, via an internal module, such as an AI-based Art Engine, rules-based generator, template system, picture-to-NFT tool, or External Image Integration Plugin, with profile images and NFTs as separate yet optionally connectable assets. Profile pictures may be usable independently of NFT minting, with optional conversion for external use or verification. Users may optionally mint badges, event achievements, or credits as NFTs via the NFT/Wallet and Encrypted Code Integration System for authenticated recognition.

An Events Module (referred to in the UI as “Get Involved”) is a core component enabling verified users to discover, filter, and attend civic or social events by location indication. For example, a location indicator may be a ZIP code, city, county, GPS coordinates, etc., tracking participation to award credits or badges. The Community and Organization Content Board (known as the “Make a Difference Board” to users) is a core component allowing verified users to browse and upvote/downvote rankable causes with actionable steps, submitted by the platform, users, businesses, or organizations. The Polling and Data Engine may power the three distinct polling boards: a Platform-Generated Content Board, a User-Submitted Content Board, and an Organization/Business/Charity Content Board. These polling boards are collectively referred to in the UI as “Vote Your Voice.” In preferred embodiments, these polling boards may enable dynamic poll, survey, and quiz interaction with ranking and visibility tied to the credit economy.

Verified users may upvote or downvote content across all boards, including but not limited to: platform-generated, user-submitted, and organization-submitted polls, surveys, quizzes, and rankable causes. By upvoting or downvoting verified users rank relevancy, which may influence visibility across segments. In preferred embodiments, ranking primarily relies on verified user actions, such as upvotes/downvotes or similar inputs. In some embodiments, ranking may optionally incorporate user credit levels, engagement scores, or platform-identified activity metrics, while maintaining organic user-led ranking as the primary mechanism. In some embodiments, users earn credits for verified activities (e.g., voting, participating, sharing), redeemable to post content, boost visibility, or unlock features.

In some embodiments, organizational contributors, including individuals, organizations, influencers, or high-net-worth users, may submit content via one-time or recurring posts. Such contributors may optionally be featured or “boosted” for visibility through payment, credits, or a subscription model. Verified users may save or follow contributors' content to personalize feeds. Organizations host paid content via a pay-to-post model and access anonymized demographic insights, filtered by age, activity, or interests, via individual or bulk data packages.

In preferred embodiments, all data shared with organizations or external entities is anonymized and governed by platform-controlled data transfer protocols. Users retain control over identifiable data, and no personal data or NFT-associated content is sold or licensed without explicit user consent. The External Image Integration Plugin may operate only under a user rights and consent agreement, and the system includes terms and conditions that users agree to before using NFT or profile image generation tools.

The Events Module includes an organization-side interface for event management, while the Community and Organization Content Board supports user-driven contributions. In some embodiments, A Live Fact-Checking Module enables real-time claim validation with AI or sourced data support. Representative Voting Alignment may compare user poll responses with elected officials' votes, public policies, organizational positions, user-generated polls, or sentiment clusters, including issue summaries. Users may share content via public links, thumbnail previews, or anonymously, receiving alerts for new polls, participation windows, or results. In some embodiments, an optional Secure Messaging System enables secure user-to-user communication, excluding platform alerts, via secure APIs or message queues. Content creation tools support manual or AI-driven poll, survey, and quiz generation, accessible via credits. Contextual data may enhance decision-making.

The platform architecture also anticipates possible extensions to include emerging data formats, such as interactive simulations or immersive content polling, and future implementations including immersive polling experiences using augmented reality (AR), virtual reality (VR), or blockchain-governed decentralized autonomous organizations (DAOs) for community-based decision-making.

Each module may operate independently or interoperable via optional secure APIs or message queues, allowing flexible deployment and customization for diverse use cases.

### Detailed Description of the Embodiments

FIG. 1-System Architecture

FIG. 1 depicts the System Architecture (100), comprising interconnected modules: User Verification System (101), Polling and Data Engine (102), Trend Processing and Poll Generator (103), User Credit and Rewards System (104), Community and Organization Content Board (105), Data Analytics and Visualization Layer (106), Sharing and Distribution Module (107), optional NFT/Wallet and Encrypted Code Integration System (108, dashed outline), optional Secure Messaging System (109, dashed outline), Events Module (110), and the required Contextual Overlay Engine (1005), integrated with the Data Insights Engine (1002). Solid boxes denote required modules, including Events Module (110), Community and Organization Content Board (105), and Contextual Overlay Engine (1005), while dashed outlines indicate optional modules (108, 109). The architecture includes three distinct polling boards-Platform-Generated Content Board, User-Submitted Content Board, and Organization/Business/Charity Content Board-powered by the Polling and Data Engine (102), collectively referred to in the UI as “Vote Your Voice.” The Community and Organization Content Board (105), known as the “Make a Difference Board” to users, enables verified users to browse and upvote/downvote rankable causes with actionable steps, submitted by the platform, users, businesses, or organizations.

The Events Module (110) enables verified users to discover, filter, and attend civic or social events by ZIP code, tracking participation to award credits or badges. It includes an organization-side interface for event management, integrated with the Sharing and Distribution Module (107).

The optional Secure Messaging System (109) enables secure user-to-user communication via secure APIs or message queues, excluding platform alerts, and interfaces with the Sharing and Distribution Module (107). Modules interact with Internal Databases and Centralized/Decentralized Servers via encrypted secure APIs or message queues, ensuring privacy and resilience.

FIG. 2-User Verification and Login Flow

FIG. 2 depicts the User Verification and Login Flow (200). Users submit identification data (e.g., name, ID, photo, biometric scan, or video) via the Verification Input Interface (201) to the Verification Processor (202), which employs internal algorithms or third-party services for authentication. Verification includes methods such as photo ID, facial recognition, video, email/SMS, two-step verification, or biometric scans. Successful verification yields an Encrypted Access Code (203) for platform login, data access, profile personalization, and integration with internal or external crypto or NFT wallets, with data stored encrypted on a Decentralized Ledger or cloud. Blockchain Wallet (204) and NFT Module (205), indicated by dashed outlines, are optional modules. The solid “Optional NFT/Wallet Linkage” arrow represents a supported integration path activated when these modules are enabled.

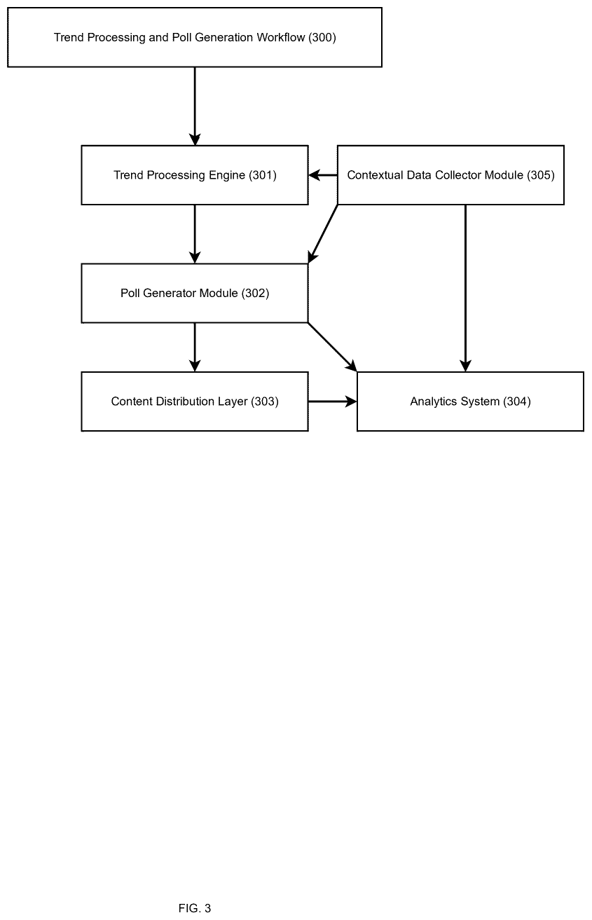

FIG. 3-Trend Processing and Poll Generation Workflow

FIG. 3 illustrates the Trend Processing and Poll Generation Workflow (300). The Polling and Data Engine (102), incorporating the Trend Processing Engine (301), identifies external trends, such as internet data, social media activity, news, and public events, alongside internal user behavior, utilizing AI/ML, NLP, algorithms, and web scraping to generate timely, relevant, and ideally neutral questions and content. The Contextual Data Collector Module (305) gathers real-time signals, including trending events, location-based interests, and demographic behavior, enhancing the Polling and Data Engine (102) to improve question neutrality and relevance. The Poll Generator Module (302) creates auto-generated questions, distributed via the Content Distribution Layer (303) and logged in the Analytics System (304). The platform, verified users, and organizations access these tools, with contextual data visualized alongside results to support decision-making.

FIG. 4-Credit Management and User Rewards

FIG. 4 illustrates the Credit Management and User Rewards System (400). The Credit Accrual Module (401) awards credits for verified activities (e.g., voting, participating, sharing), stored in the Credit Wallet (402) for redeeming content (403), boosting visibility (404), or unlocking features. The Rewards Dashboard (405) and Admin Console (406) manage transactions, logged in a tamper-resistant ledger. The Credit Wallet (402) and Rewards Dashboard (405) optionally interface with the NFT/Wallet and Encrypted Code Integration System (108) to export badges, achievements, or participation data as NFTs. Event participation via the Events Module (110) triggers credit accrual or badge issuance, reflected in the Rewards Dashboard (405) and Credit Wallet (402), with optional NFT minting.

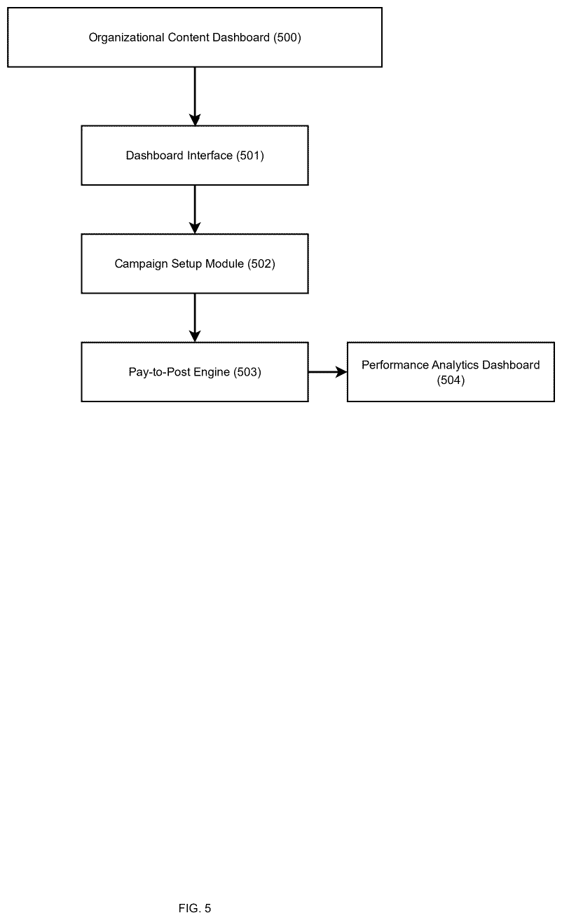

FIG. 5-Organizational Content Dashboard

FIG. 5 depicts the Organizational Content Dashboard (500). The Dashboard (501) enables organizations to create campaigns via the Campaign Setup Module (502), processed by the Pay-to-Post Engine (503), with metrics displayed on the Performance Analytics Dashboard (504). Organizations access anonymized demographic insights, filtered by age, activity, or interests, and user activity trends via individual or bulk data packages. Event participation via the Events Module (110) may result in credit accrual or badge issuance, reflected in the Rewards Dashboard (405) and Credit Wallet (402), with optional NFT minting.

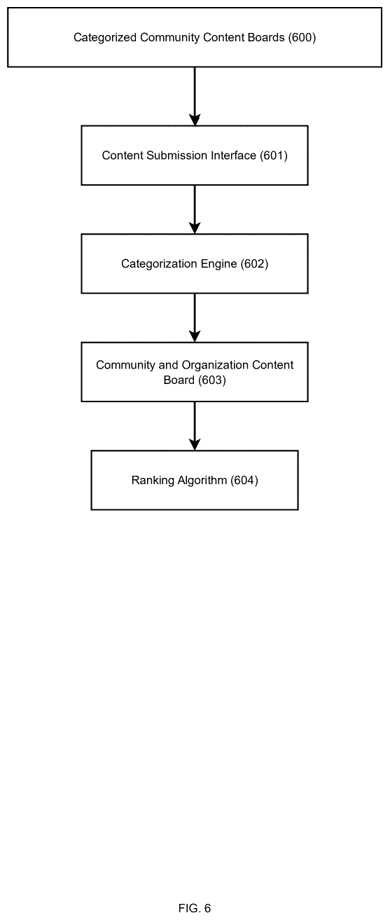

FIG. 6-Categorized Community Content Boards

FIG. 6 depicts the Categorized Community Content Boards (600). The Content Submission Interface (601) routes submissions to the Categorization Engine (602) for display on the User-Submitted Content Board (603), ranked by the Ranking Algorithm (604) based on user upvotes or downvotes, influencing visibility across segments. This algorithm applies uniformly to polls, surveys, quizzes, and rankable causes displayed on the Make a Difference Board.

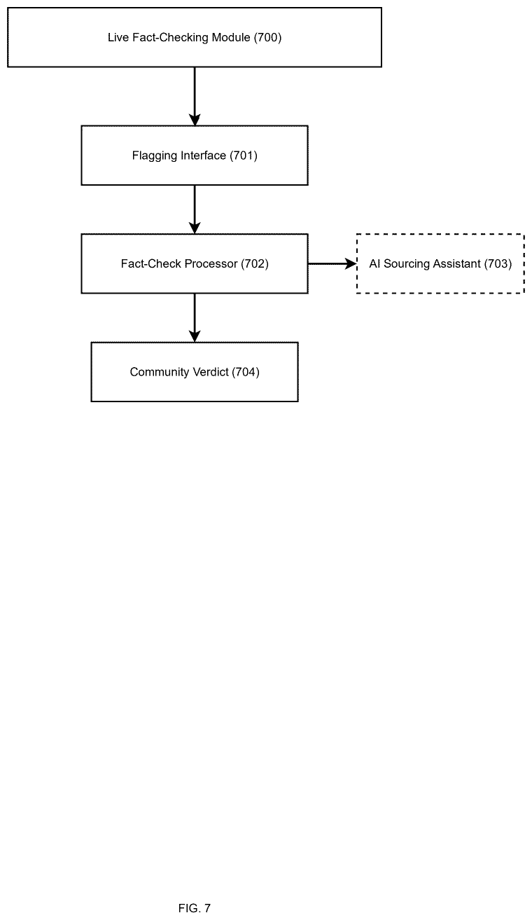

FIG. 7-Live Fact-Checking Module

FIG. 7 illustrates the Live Fact-Checking Module (700). The Flagging Interface (701) triggers validation by the Fact-Check Processor (702), aided by the AI Sourcing Assistant (703), yielding a Community Verdict (704) through real-time claim review, supporting public verdicts during debates or trending news.

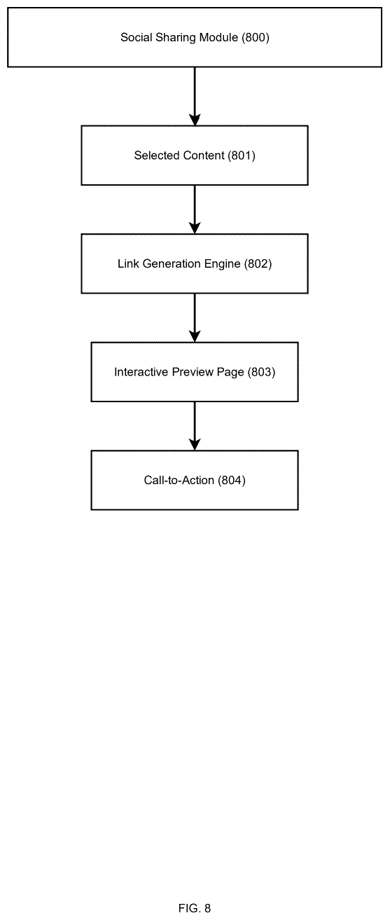

FIG. 8-Social Sharing Module

FIG. 8 depicts the Social Sharing Module (800). The Link Generation Engine (802) creates shareable URLs from content (801), leading to an Interactive Preview Page (803) with a Call-to-Action (804). Users share via public links, thumbnail previews, or anonymously, receiving alerts for new polls, participation windows, or results.

FIG. 9-Wallet and NFT Integration

FIG. 9 details the Wallet and NFT Integration Module (900). The Wallet Connection Module (901) links to a Blockchain Wallet, with the AI Art Generation Module (902) or an integrated plugin creating NFTs via the NFT Minting Engine (903). Digital assets, including profile pictures or NFTs, are generated via an internal module, such as an AI-based Art Engine, rules-based generator, template system, picture-to-NFT tool, or External Image Integration Plugin, treated as separate yet connectable assets. Profile images are usable independently of NFT minting but may be linked or converted. The system distinguishes between profile images used within the platform and NFTs. While NFTs may be minted from profile images, these two assets are functionally independent unless explicitly linked by the user. The Credit/Achievement Conversion Module (909) converts badges, credits, or achievements into NFTs, interfacing with the Credit Wallet (402) and Rewards Dashboard (405) from FIG. 4, supporting optional minting for identity, engagement, or tracking. The External Image Integration Plugin operates only under a user rights and consent agreement, ensuring lawful use of user-provided or third-party image-based inputs for profile or NFT generation. No personal data or NFT-associated content is sold or licensed without explicit user consent.

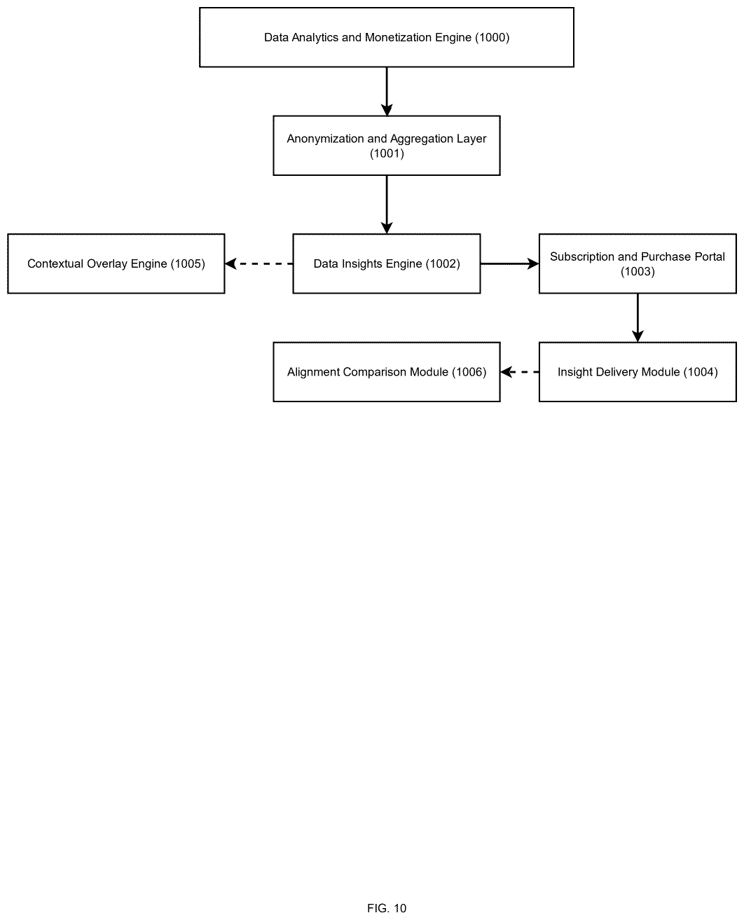

FIG. 10-Data Analytics and Monetization Engine

FIG. 10 illustrates the Data Analytics and Monetization Engine (1000). The Anonymization and Aggregation Layer (1001) removes personally identifiable information, grouping data into cohorts for the Data Insights Engine (1002). The Subscription and Purchase Portal (1003) delivers reports (1004) comparing user responses to elected officials' votes, business decisions, or benchmarks, with summaries. The Alignment Comparison Module (1006) compares poll responses, trends, or activity to entities like officials, legislation, or sentiment clusters. The required Contextual Overlay Engine (1005), integrated with the Data Insights Engine (1002), provides visualized auxiliary data alongside poll, survey, or quiz outputs based on user or cohort attributes to enable contextual interpretation of results by displaying relevant user traits, demographic behavior, or trend data for enhanced decision support. The Insight Delivery Module (1004) provides downloadable or interactive reports. Contextual data enhances decision-making.

FEATURES LIST

| | |
|---|---|
| System Architecture | (100) |
| User Verification S | (101) |
| Polling and Data Engine | (102) |
| Trend Processing and Poll Generator | (103) |
| User Credit and Rewards System | (104) |
| Community and Organization Content Board | (105) |
| Data Analytics and Visualization Layer | (106) |
| Sharing and Distribution Module | (107) |
| NFT/Wallet and Encrypted Code Integration System | (108) |
| Secure Messaging System | (109) |
| Events Module | (110) |
| User Verification and Login Flow | (200) |
| Verification Input Interface | (201) |
| Verification Processor | (202) |
| Encrypted Access Code | (203) |
| Blockchain Wallet | (204) |
| NFT Module | (205) |
| Secure Login Module | (206) |
| Trend Processing and Poll Generation Workflow | (300) |
| Trend Processing Engine | (301) |
| Poll Generator Module | (302) |
| Content Distribution Layer | (303) |
| Analytics System | (304) |
| Contextual Data Collector Module | (305) |
| Credit Management and User Rewards System | (400) |
| Credit Accrual Module | (401) |
| Credit Wallet | (402) |
| Redeemable Content Access Module | (403) |
| Visibility Boost Module | (404) |
| Rewards Dashboard | (405) |
| Admin Console | (406) |
| Organizational Content Dashboard | (500) |
| Dashboard Interface | (501) |
| Campaign Setup Module | (502) |
| Pay-to-Post Engine | (503) |
| Performance Analytics Dashboard | (504) |
| Categorized Community Content Boards | (600) |
| Content Submission Interface | (601) |
| Categorization Engine | (602) |
| Community and Organization Content Board | (603) |
| Ranking Algorithm | (604) |
| Live Fact-Checking Module | (700) |
| Flagging Interface | (701) |
| Fact-Check Processor | (702) |
| AI Sourcing Assistant | (703) |
| Community Verdict | (704) |
| Social Sharing Module | (800) |
| Selected Content | (801) |
| Link Generation Engine | (802) |
| Interactive Preview Page | (803) |
| Call-to-Action | (804) |
| Wallet and NFT Integration Module | (900) |
| Wallet Connection Module | (901) |
| AI Art Generation Module | (902) |
| NFT Minting Engine | (903) |
| NFT Storage Module | (904) |
| External Image Integration Plugin | (905) |
| Rules-Based Generator | (906) |
| Template System | (907) |
| Picture-to-NFT Converter | (908) |
| Credit/Achievement Conversion Module | (909) |
| Data Analytics and Monetization Engine | (1000) |
| Anonymization and Aggregation Layer | (1001) |
| Data Insights Engine | (1002) |
| Subscription and Purchase Portal | (1003) |
| Insight Delivery Module | (1004) |
| Contextual Overlay Engine | (1005) |
| Alignment Comparison Module | (1006) |

What is claimed is:

1. A digital platform for generating and managing user engagement through polls, surveys, and quizzes, wherein said platform supports content ranking and interaction through a credit-based economy, applicable to polls, surveys, quizzes, and rankable causes, comprising:
a) A Verification Module configured to authenticate a user via the application or a third-party service using methods comprising photo ID, facial recognition, video, email/SMS, two-step verification, or biometric scans;
b) An Encrypted Code Module configured to issue a unique Encrypted Access Code to the verified user for platform login, data access, profile personalization, and integration with internal or external crypto or NFT wallets;
c) A Polling and Data Engine configured to identify relevant topics from at least one of:
internet data, social media activity, internal user trends, web scraping, artificial intelligence, machine learning, or curated sources, filtering content for neutrality to generate timely, relevant, and ideally neutral questions and content;
d) A Content Creation Module configured to enable the platform, verified users, and organizational entities to create manually or generate automatically polls, surveys, and quizzes using trend data;
e) A User Interface configured to display said polls, surveys, and quizzes to verified users and collect responses;
f) A Credit Management Module configured to allocate credits for verified activities, the verified activities comprising voting, participating, or sharing, and permit content submission or feature unlocking using said credits;
g) A Community Content Board, comprising a Platform-Generated Content Board, a User-Submitted Content Board, an Organization/Business/Charity Content Board, and a Make a Difference Board, each configured to display polls, surveys, quizzes, or rankable causes with actionable steps;
h) An Organizational Content Dashboard configured to display paid content with a payment-based prioritization system and metrics dashboard;
i) A Data Analytics Module configured to generate insights and visualizations, comprising representative alignment with elected officials' votes, organizational actions, policy comparisons, and content-based benchmarks over time, using an Anonymization Layer that removes personally identifiable information and aggregates data into cohorts, which are then integrated into the required Contextual Overlay Engine to support visualized insights and contextual decision-making;
j) A Sharing Module configured to share interactive content externally via public links, thumbnail previews, or optional anonymous sharing, and provide platform alerts for new poll releases, participation windows, or final results;
k) An optional Secure Messaging System configured to enable secure, private user-to-user communication through secure APIs or message queues, excluding platform-initiated communications, comprising alerts and administrative messages, transmitted via separate components;
l) An optional NFT/Wallet and Encrypted Code Integration System configured to connect the encrypted identifier to a Blockchain Wallet and generate digital assets, comprising profile pictures or NFTs, using an internal or external generator, comprising an AI-based Art Engine, a template-based system, a rules-based image generator, a picture-to-NFT conversion tool, or an External Image Integration Plugin;
m) A Server Module comprising multiple rotating independent Centralized/Decentralized Servers configured to host the platform and provide enhanced security, with all communications encrypted via secure APIs or message queues, supporting decentralized ledgers and an anonymization layer.

2. The system of claim 1, wherein users are prompted with polls, surveys, and quizzes based on interaction history, preferences, or location.

3. The system of claim 1, wherein credits are earned for responding, civic engagement, or sharing, redeemable for promotion or NFT customization.

4. The system of claim 1, further comprising an Events Module configured to enable searching by postal code for public engagement, wherein participation is tracked to award credits or badges, and an organization-side interface for event creation, hosting, and tracking.

5. The system of claim 1, further comprising a Live Fact-Checking Module configured for real-time validation of claims, supporting public verdicts backed by AI or sourced data assistants.

6. The system of claim 1, wherein alerts are configured to notify users of poll updates.

7. The system of claim 1, wherein the Data Analytics Module is configured to enable subscription to or purchase of anonymized demographic-based insights, filtered by age, activity, or interests, and access to user activity or engagement trends via individual poll reports or bulk data packages.

8. The system of claim 1, wherein the verification performed by the Verification Module comprises facial recognition or video confirmation.

9. The system of claim 1, wherein the Decentralized Ledger is configured to support blockchain-based authentication.

10. The system of claim 1, wherein the Secure Messaging System is configured to support group chats through encrypted message queues.

11. The system of claim 1, wherein the Content Creation Module is configured to provide secure API access for organizational entities.

12. The system of claim 4, wherein event participation is tracked and displayed via the User Dashboard, the user-facing interface aggregating features such as the Rewards Dashboard, Credit Wallet, Event Participation Tracker, and related user engagement metrics.

13. The system of claim 1, wherein the Make a Difference Board within the Community Content Board is configured to list rankable causes with actionable steps, submitted by the platform, users, businesses, or organizations.

14. The system of claim 1, wherein the Polling and Data Engine powers and delivers content to the Platform-Generated Content Board, User-Submitted Content Board, and Organization/Business/Charity Content Board, collectively referred to as ‘Vote Your Voice’ in the platform UI, facilitating dynamic poll, survey, and quiz interaction with credit-linked ranking and visibility.

15. The system of claim 1, wherein content ranking is determined by user upvotes and downvotes, and optionally adjusted by user activity metrics, credit levels, or platform-identified engagement scores.

16. A method for user interaction, comprising:
a) Verifying user identity using biometric scan, video confirmation, or two-step authentication;
b) Issuing an Encrypted Access Code storable on a blockchain;
c) Generating trend-based polls using artificial intelligence or machine learning;
d) Rewarding credits based on participation metrics;
e) Enabling content creation and secure user-to-user messaging through encrypted APIs or message queues; and
f) Displaying ranked results on a Community Content Board.

17. The method of claim 16, further comprising generating neutral poll questions using a Trend Processing Engine.

18. The system of claim 1, wherein the platform is configured to incorporate and display contextual data, including but not limited to trending events, demographics, and behavioral insights, gathered from internal or external sources and visualized alongside poll or survey results to support informed decision-making.

19. The system of claim 1, further comprising a Contextual Overlay Engine configured to visualize contextual data, including but not limited to trending events, user traits, behavioral signals, or demographic insights, integrated with the Data Insights Engine to display auxiliary information alongside poll, survey, or quiz results for enhanced decision support.

20. The system of claim 1, wherein earned badges, credits, or event achievements from the User Credit and Rewards System are mintable as NFTs through the NFT/Wallet and Encrypted Code Integration System.
